(19) United States
(12) Patent Application Publication
(10) Pub. No.: US 2009/0097382 A1
(43) Pub. Date: Apr. 16, 2009

(54) OBJECTIVE LENS DRIVING DEVICE AND OPTICAL DISC DEVICE

(75) Inventors: Masayuki Fujita, Tokyo (JP); Yoshihisa Nagashima, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: NEC CORPORATION, Tokyo (JP)

(21) Appl. No.: 11/915,815

(22) PCT Filed: May 30, 2006
(86) PCT No.: PCT/JP2006/311167

§ 371 Date: Nov. 28, 2007

(30) Foreign Application Priority Data
May 31, 2005 (JP) 2005-158863

(51) Int. Cl. G11B 7/135

(52) U.S. Cl. 369/112.23; G9B/7.112

(57) ABSTRACT

Each of sensors (16a, 16b) has a light-receiving portion and a light-emitting portion and outputs a signal according to light received by the light-receiving portion. The sensors (16a, 16b) face an actuator movable portion (26) in the tangential direction. The sensors (16a, 16b) are symmetrically arranged with respect to the centerline of the actuator movable portion (26) in the radial direction. When the actuator movable portion (26) is displaced in the radial direction, an output of one of the sensors (16a, 16b) is greater than an output of the other. Then, the difference between the two outputs is obtained to detect the displacement of the actuator moving part (26) in the radial ditection.

### TECHNICAL FIELD

This invention relates to an objective lens driving device and an optical disc device and, more specifically, relates to an optical disc device that performs recording/reproduction of information on/from an optical disc using a light spot and an objective lens driving device for use in such an optical disc device.

### BACKGROUND ART

In recent years, optical disc devices have been widely used as peripheral input/output devices of personal computers or household optical disc recorders. In these markets, the need is increasing for a further increase in capacity of optical discs by the improvement in recording density and a further increase in recording/reproducing speed.

The development of optical discs has been progressing from CD (Compact Disc) to DVD (Digital Versatile Disc) and further to HD DVD (High Definition DVD), wherein an increase in capacity has been realized by shortening the wavelength of laser light from infrared to red and further to blue. Various optical disc standards are established with different physical formats in respective wavelength bands. Currently, various discs are on the market, such as a disc increased in recording density by land/groove recording that performs recording both on land and groove and a disc with different track pitches. An optical disc device adapted for these plurality of standards requires an optical head that is adapted for the respective standards and there has been developed an optical head that is adaptable for the land/groove recording and various track widths.

As an optical head that controls a light spot on a disc by driving an objective lens in the focusing direction and the tracking direction, there is known, for example, one described in the publication of Japanese Patent No. 2760307. In this type of optical head, use was generally made of a differential astigmatism method for the focusing direction and a differential push-pull (DPP) method for the tracking direction as error detection means for controlling the position of a light spot on a disc. However, in the case of a disc employing land/groove recording or a disc with different track pitches, use is made, for adaptation to the disc, of a double knife-edge method for detection in the focusing direction and an error signal detection method such as an in-line DPP method for detection in the tracking direction. These methods require a detection optical system to be more complicated and, following it, there arises a problem such as noise sneaking into an objective-lens position error signal when there occurs an offset between an objective lens and an optical axis. Therefore, it becomes necessary to detect the position of the objective lens from other than a light beam used for recording/reproduction of information.

As an optical head incorporating an objective lens driving device capable of detecting the displacement of an objective lens in the radial direction using sensors, there is known one having a structure shown in FIGS. 1 and 2 (HOP-8541T manufactured by Hitachi Media Electronics Co., Ltd.). A lens holder 52 is mounted with an objective lens 51 and cantilevered to a damper box 61 by support members 60. Both end surfaces, in the radial direction, of the lens holder 52 are formed flat. In an objective lens driving device 50, two sensors 56 are attached so as to face the flat end surfaces of the lens holder 52, thereby sandwiching the lens holder 52 in the radial direction.

Each sensor 56 has a light-emitting portion 57 and a light-receiving portion 58 arranged in the tangential direction. Light emitted from the light-emitting portion 57 is reflected on the end surface of the lens holder 52 and is incident on the light-receiving portion 58. The sensor 56 outputs a signal corresponding to the amount of light received by the light-receiving portion 58. The output of the sensor 56 changes depending on the distance between the sensor 56 and the lens holder 52. Therefore, the objective lens driving device 50 can detect the displacement of the objective lens 51 in the radial direction by deriving a difference in output between the two sensors 56.

FIG. 3 is a plan view showing another conventional objective lens driving device that detects the position of an objective lens using a sensor. This objective lens driving device employs a hinge-type objective lens driving structure. A sensor 76 has one light-emitting portion 77 and two light-receiving portions 78a and 78b. A reflection plate 79 reflects light emitted from the light-emitting portion 77 and the light-receiving portions 78a and 78b each receive reflected light from the reflection plate 79. The reflection plate 79 is configured to move in response to the displacement of an objective lens 71 in the radial direction and, in this objective lens driving device, the displacement of the objective lens 71 in the radial direction can be detected by deriving a difference in output between the respective light-receiving portions 78a and 78b.

In the meantime, in order to further increase the capacity of an optical disc, it is expected to be necessary hereafter to expand a recording area toward the inner peripheral side of the disc to thereby ensure as large an area as possible on the disc as a data recording area. Accordingly, it is desirable that an optical head incorporating an objective lens driving device be reduced in size particularly in the radial direction to thereby increase an access area with respect to an optical disc. However, in the conventional objective lens driving device 50 (FIGS. 1 and 2), since the sensors 56 are disposed at the positions so as to sandwich the lens holder 52 from its both ends in the radial direction, the width in the radial direction increases so that it is difficult to miniaturize the optical head. Accordingly, there is a problem that the optical head incorporating the objective lens driving device 50 interferes with a corn portion of a spindle motor or with a turntable in accessing an inner peripheral portion of an optical disc, so that an access area is restricted.

Further, in the conventional objective lens driving device 50, in order to detect the displacement of the lens holder 52 in the radial direction at the respective positions of the lens holder 52 in the focusing direction, it is necessary that the end surfaces, facing the sensors 56, of the lens holder be formed flat even when the lens holder 52 is located at any position in the focusing direction. Therefore, there is a problem that the flat end surfaces of the lens holder 52 each need to have a considerable area also in the focusing direction and thus the end surfaces, in the radial direction, of the lens holder 52 cannot be reduced in weight.

Normally, the lens holder 52 is longer in the radial direction than in the tangential direction. This is because focusing and tracking coils for driving the lens holder 52 need to be attached to the plane parallel to the radial direction. Thus, the lens holder 52 has a natural resonance point, i.e. “bending” or “twist”, at a frequency of approximately several tens of KHz due to the weights at the end portions in the radial direction.

FIG. 4 shows frequency characteristics of the lens holder 52. In FIG. 4, graph line (a) represents a gain (dB) determined according to the ratio between an amplitude of a drive signal for the lens holder 52 and its response and graph line (b) represents a drive phase delay. Referring to FIG. 4, it is seen that the frequency characteristics of gain and phase delay are disturbed at a frequency band of several tens of KHz, surrounded by a circle, due to the influence of the natural resonance point in a Bode diagram.

Here, in increasing the recording/reproducing speed with respect to an optical disc, it becomes necessary to accurately control an objective lens to a required position even with fluctuation of a desired condensed spot position due to surface runout, eccentricity, or the like caused by an increase in disc rotation speed and thus it becomes necessary to improve the operating frequency band of an objective lens driving device. Further, as a result of the popularization of the optical disc market, those discs with poor quality appear on the market and therefore the necessity of improving the operating frequency band is increasing more and more. However, since the conventional objective lens driving device 50 has the natural resonance point at the frequency of several tens of KHz as described above, there is a problem that the operating band cannot be increased.

Generally, when the frequency characteristics of the lens holder 52 are indicated by the Bode diagram as shown in FIG. 4, if the gain decreases at a constant rate (e.g. −40 dB in the range from 1 k to 10 k), the control is facilitated. However, since, as described above, the frequency characteristics are disturbed in the frequency band around several tens of KHz in the conventional objective lens driving device, there is a problem that it is difficult to accurately control the lens holder 52.

On the other hand, in the objective lens driving device having the structure shown in FIG. 3, the special sensor 76 having one light-emitting portion 77 and two light-receiving portions 78a and 78b is required as the sensor 76 for lens position detection. Since such a special sensor is required, there is a problem that the structure of the optical head becomes complicated and thus the cost increases with an increase in the number of parts.

In recent years, the laser light power necessary for high-speed recording and so on has been increasing following the increase in capacity of optical discs and, therefore, the internal temperature of optical disc drives has been increasing more and more. In the high-temperature environment, there is a case where the tilt of an objective lens occurs due to slight variation in assembling an objective lens driving device, for example, a stress at the time of bonding support members and a change in internal stress caused by inclination of the support members, a difference in length between the left and right support members, and so on. If such a tilt of the objective lens occurs, there arises a difference between a target value of tilt control and an actual tilt and thus a light spot on a disc cannot be correctly controlled.

If the tilt of the objective lens due to the temperature rise is within the margin range, there arises no serious problem on the recording/reproducing characteristics. However, with respect to capacity-increased discs, there is a problem that the margin for the tilt of objective lenses has been narrowed more and more and thus the recording/reproducing quality is degraded even by a slight tilt. The actual tilt of the objective lens cannot be detected in either of the objective lens driving devices having the structures shown in FIGS. 1 to 3 and, therefore, there is a problem that if the objective lens is tilted with respect to the designed state, the tilt of the objective lens cannot be accurately controlled to a desired tilt.

### DISCLOSURE OF THE INVENTION

It is an object of this invention to solve the foregoing prior art problems and to provide an objective lens driving device and an optical disc device that can detect a displacement and a tilt of an objective lens without increasing the size of the objective lens driving device in the radial direction.

It is another object of this invention to provide an objective lens driving device and an optical disc device having excellent high-order resonance characteristics.

It is still another object of this invention to provide an objective lens driving device and an optical disc device that can correctly control a tilt of an objective lens even when the objective lens is digressively tilted from the designed state.

The other objects of this invention not specified here will become apparent from the following description and the accompanying drawings.

An objective lens driving device of this invention is an objective lens driving device for driving a lens mounting portion, on which an objective lens focusing light onto an optical disc is mounted, in at least a focusing direction and a radial direction with respect to a reference position and is characterized by comprising an optical sensor having a light-emitting portion and a light-receiving portion, said optical sensor facing an end surface, in a tangential direction or the focusing direction, of the lens mounting portion near an end, in the radial direction, of the lens mounting portion, wherein at least one of a displacement and a tilt of the lens mounting portion is detected based on an output of the optical sensor.

In the objective lens driving device of this invention, the optical sensor for detecting at least one of the displacement and the tilt of the lens mounting portion is disposed so as to face the lens mounting portion in the tangential direction or the focusing direction near the end, in the radial direction, of the lens mounting portion. Therefore, as compared with the conventional objective lens driving device in which the optical sensors are disposed so as to sandwich the lens mounting portion in the radial direction, the size can be reduced in the radial direction. Further, since it is not necessary to form a considerable area of either of the end surfaces, in the radial direction, of the lens mounting portion to be flat, the end portions, in the radial direction, of the lens mounting portion can be reduced in weight. In this case, excellent high-order resonance characteristics can be realized to increase the operating frequency band of the objective lens driving device.

In the objective lens driving device of this invention, it is possible to employ a structure in which the optical sensor faces the end surface in the tangential direction and the light-emitting portion and the light-receiving portion of the optical sensor are arranged along the focusing direction. Alternatively, instead of it, it is also possible to employ a structure in which the optical sensor faces the end surface in the focusing direction and the light-emitting portion and the light-receiving portion of the optical sensor are arranged along the tangential direction.

In the objective lens driving device of this invention, it is possible to employ a structure in which the optical sensor comprises a pair of optical sensors disposed near both ends, in the radial direction, of the lens mounting portion. In this case, the displacement or the tilt of the lens mounting portion can be detected based on outputs of the pair of optical sensors each adapted to output a signal of an output corresponding to the amount of light received by the light-receiving portion.

In the objective lens driving device of this invention, it is possible to employ a structure in which the pair of optical sensors are arranged symmetrically with respect to a centerlineline, in the radial direction, of the objective lens driving device. In this case, in the optical sensors, the amounts of light received by the light-receiving portions become equal to each other when the displacement of the lens mounting portion in the radial direction is 0. On the other hand, when the lens mounting portion is displaced in the radial direction from its neutral position, the amount of light received by the light-receiving portion of one of the optical sensors increases or decreases as compared with the amount of light received by the light-receiving portion of the other optical sensor. Therefore, the displacement of the lens mounting portion in the radial direction can be detected, for example, by deriving a difference between the outputs of both optical sensors.

In the objective lens driving device of this invention, it is possible to employ a structure in which a layout order of the light-emitting portion and the light-receiving portion of one of the pair of optical sensors and a layout order of the light-emitting portion and the light-receiving portion of the other of said optical sensors are opposite to each other. In this case, when the lens mounting portion is tilted in a radial tilt direction, the output of each optical sensor changes according to the tilt. Therefore, the tilt of the lens mounting S portion can be detected, for example, by deriving the sum of the outputs of the optical sensors.

In the objective lens driving device of this invention, it is possible to employ a structure in which a layout order of the light-emitting portion and the light-receiving portion of one of the pair of optical sensors and a layout order of the light-emitting portion and the light-receiving portion of the other of said optical sensors are the same as each other. In this case, the displacement of the lens mounting portion in the radial direction can be detected by deriving a difference between the outputs of the pair of optical sensors.

In the objective lens driving device of this invention, it is possible to employ a structure in which the center, in the radial direction, of the optical sensor is located outside the end, in the radial direction, of the lens mounting portion. In this case, a change in output of the sensor with respect to a change in displacement or tilt of the lens mounting portion becomes gradual near the neutral position (radial-direction displacement 0, radial-tilt-direction tilt angle 0) of the lens mounting portion, so that it becomes easy to detect even a slight change in displacement or tilt.

In the objective lens driving device of this invention, it is possible to employ a structure in which the end surface in the tangential direction of the lens mounting portion is formed by a surface of a sheet coil accommodating drive coils serving to drive the lens mounting portion in the tangential direction, the radial direction, and the tilt direction. Normally, coils for driving a lens mounting portion in the respective directions are attached to an end surface in the tangential direction of the lens mounting portion. In the objective lens driving device of this invention, when employing the structure in which the optical sensor faces the lens mounting portion in the tangential direction, the surface of the sheet coil having such coils can be used as the end surface in the tangential direction of the lens mounting portion facing the optical sensor.

In the objective lens driving device of this invention, it is possible to employ a structure in which the lens mounting portion is formed with an opening for guiding laser light to be incident on the objective lens. In this case, it is not necessary to guide laser light to enter from the lower side of the lens mounting portion and, therefore, an optical head device incorporating the objective lens driving device can be reduced in thickness.

In the objective lens driving device of this invention, a photointerrupter can be used as the optical sensor.

An objective lens driving device of this invention is an objective lens driving device comprising an objective lens, a lens holder mounted with the objective lens, a support member movably supporting the lens holder, a coil member fixed to an end, in a tangential direction, of the lens holder, and a magnet facing the coil member, thereby moving the lens holder in at least a radial direction and the tangential direction, and is characterized by comprising a pair of optical sensors each having a light-emitting portion and a light-receiving portion arranged along a focusing direction, the pair of optical sensors facing an end surface, in the tangential direction or the focusing direction, of the lens holder near both ends, in the radial direction, of the lens holder, wherein at least one of a displacement and a tilt of the lens holder is detected based on outputs of the optical sensors.

An optical disc device of this invention is an optical disc device for irradiating laser light onto an optical disc to perform recording/reproduction of information and is characterized by comprising the foregoing objective lens driving device of this invention.

### BRIEF DESCRIPTION OF THE DRAWINGS

FIG. 1 is a perspective view showing the structure of a conventional objective lens driving device that detects the position of an objective lens using sensors,

FIG. 2 is a plan view showing the objective lens driving device of FIG. 1;

FIG. 3 is a plan view showing another conventional objective lens driving device that detects the position of an objective lens using a sensor;

FIG. 4 is a graph showing frequency characteristics of a lens holder in the conventional objective lens driving device;

FIG. 5 is a plan view showing an optical disc device including an objective lens driving device of a first embodiment of this invention;

FIG. 6 is a perspective view showing the structure of an optical head device;

FIG. 7 is a developed perspective view showing the structure of the objective lens driving device;

FIG. 8 is a plan view showing the optical head device;

FIG. 9 is a diagram showing the positional relationship between an actuator movable portion and two sensors;

FIGS. 10A to 10C are exemplary diagrams showing the states of detection of positions in the radial direction of the actuator movable portion;

FIG. 11 is a graph showing the relationship between the difference of output signals of the two sensors and the displacement in the radial direction of the actuator movable portion;

FIGS. 12A to 12C are exemplary diagrams showing the states of detection of tilts in the radial tilt direction of the actuator movable portion;

FIG. 13 is an exemplary diagram showing the relationship between the sum of output signals of the two sensors and the tilt in the radial tilt direction of the actuator movable portion;

FIG. 14 is a block diagram showing the configuration of an objective lens tilt control section in the optical head device;

FIG. 15A is a perspective view showing part of the objective lens driving device of the first embodiment;

FIG. 15B is a perspective view showing part of the conventional objective lens driving device as a comparative example;

FIG. 16 is a graph showing the evaluation results of frequency characteristics in the objective lens driving device of the first embodiment;

FIG. 17 is a plan view showing part of an objective lens driving device of a second embodiment of this invention;

FIG. 18 is a diagram showing the positional relationship between an actuator movable portion and two sensors in an objective lens driving device in which light-emitting portions and light-receiving portions are laterally symmetrically arranged;

FIG. 19 is a diagram showing the positional relationship between an actuator movable portion and two sensors in an objective lens driving device in which the centers in the radial direction of the sensors are arranged outside the ends of a sheet coil;

FIG. 20 is a developed perspective view showing the structure of an objective lens driving device in which sensors face an actuator movable portion in the focusing direction; and

FIG. 21 is a plan view showing the objective lens driving device of FIG. 20.

### BEST MODE FOR CARRYING OUT THE INVENTION

An objective lens driving device and an optical disc device of this invention each have an optical sensor, for detecting at least one of a displacement and a tilt of a lens mounting portion, at a position facing an end surface, in a focusing direction or a tangential direction, of the lens mounting portion. This makes it possible to reduce the size of the objective lens driving device in a radial direction, so that it is possible to easily access an innermost peripheral area of an optical disc by reducing the restriction of access area in accessing the inner peripheral side of the disc. Further, end portions, in the radial direction, of the lens mounting portion can be reduced in weight, so that it is possible to increase the operating frequency band of the objective lens driving device.

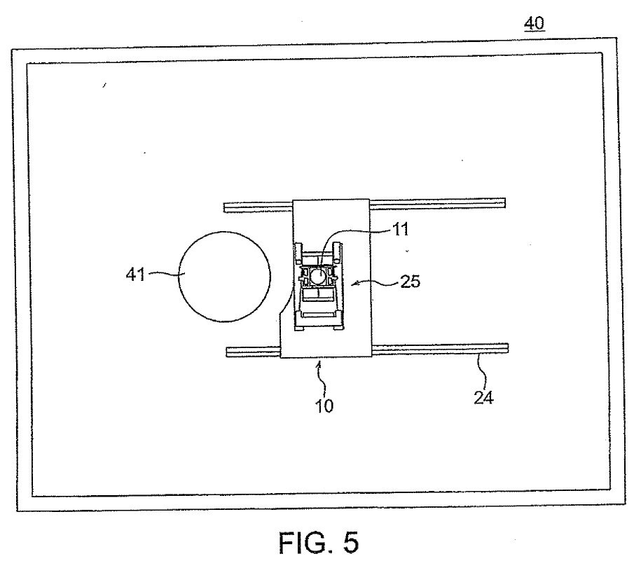

Hereinbelow, embodiments of this invention will be described in detail with reference to the drawings. FIG. 5 is a plan view showing an optical disc device including an objective lens driving device of the first embodiment of this invention. An optical head device 10 incorporates an objective lens driving device 25 adapted to drive an objective lens 11 and is configured to be movable along rails 24 in the radius direction (radial direction) of an optical disc. A spindle motor 41 rotates the optical disc. The optical disc device 40 records data on the optical disc or reproduces data recorded on the optical disc using laser light emitted from the objective lens 11.

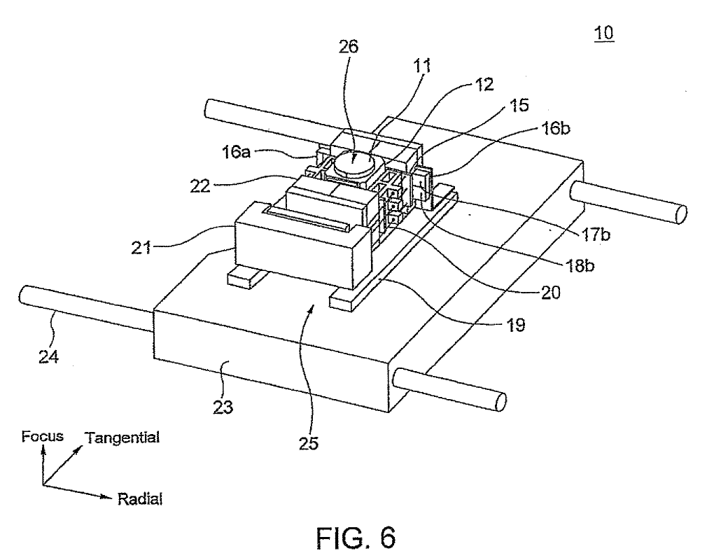

FIG. 6 is a perspective view showing the neighborhood of the optical head device 10. The optical head device 10 comprises the objective lens driving device 25 and a carriage 23 mounted thereon with the objective lens driving device 25. The objective lens driving device 25 comprises the objective lens 11, a lens holder 12, sheet coils 15, sensors 16, a base 19, a damper box 21, and magnets 22. The objective lens 11, the lens holder 12, and the sheet coils 15 constitute an actuator movable portion 26. The damper box 21, the magnets 22, and the sensors 16 are respectively fixed to the base 19. A mechanism for driving the actuator movable portion 26 in the objective lens driving device 25 is the same as an objective lens driving mechanism in the objective lens driving device described in the publication of Japanese Patent No. 2760307.

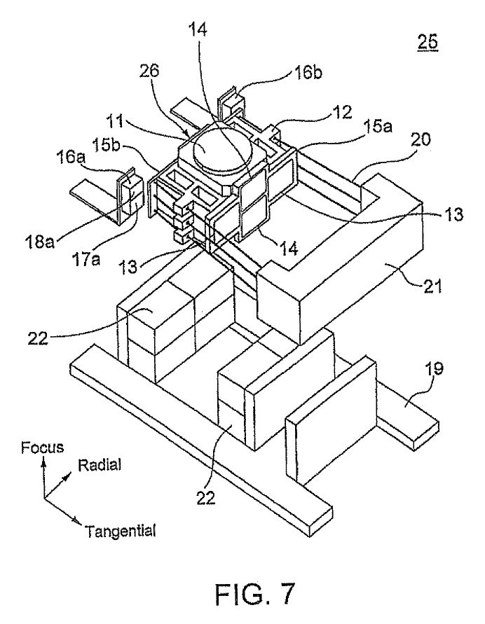

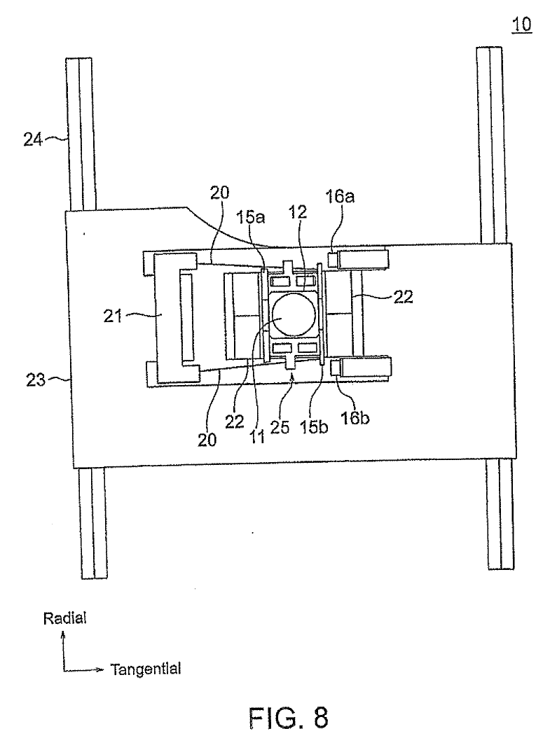

FIG. 7 is a developed perspective view showing the objective lens driving device 25 and FIG. 8 is a plan view showing the optical head device 10 of FIG. 6. The objective lens 11 is mounted on the lens holder 12. The objective lens 11 condenses laser light, emitted from a non-illustrated laser diode, onto an information recording surface of the optical disc. The lens holder 12 is cantilevered by six support members 20 each fixed to the damper box 21 at its one end. The sheet coils 15a and 15b are attached to both ends, in the tangential direction, of the lens holder 12.

The magnets 22 are disposed at positions facing the sheet coils 15, respectively. The base 19 serves as a yoke of a magnetic circuit and has a function of enhancing the distribution efficiency of the magnetic field intensity generated by the magnets 22. Each magnet 22 is quartered vertically and horizontally (in focusing and radial directions), wherein the direction of magnetic force is determined so that an N-pole and an S-pole are adjacent to each other at each of the boundaries between the divisions. For example, if the upper left of the magnet 22 is set to the N-pole, the lower left and the upper right are set to the S-pole and the lower right is set to the N-pole.

The sheet coils 15a and 15b each have a pair of focusing coils 13 and a pair of tracking coils 14 pattern-formed on a substrate. The pair of focusing coils 13 are opposed to the neighborhood of a horizontal dividing line of the magnet 22 in the assembled state. On the other hand, the pair of tracking coils 14 are opposed to the neighborhood of a vertical dividing line of the magnet 22 in the assembled state. The sheet coil 15a further comprises a non-illustrated radial tilt coil. This radial tilt coil is stacked with the focusing coils 13 and the tracking coils 14 in the sheet coil 15a and is opposed to the neighborhood of the horizontal dividing line of the magnet 22.

The support members 20 are conductive and the current is supplied to the respective coils of the sheet coils 15 through the support members 20. The lens holder 12 (actuator movable portion 26) is movable with respect to the base 19 (stationary portion) in the respective directions, i.e. the focusing direction, the tracking direction, and the radial tilt direction, by electromagnetic forces acting between the respective coils of the sheet coils 15 and the magnets 22. Thus, it is possible to cause the objective lens 11 to follow fluctuations such as surface runout and eccentricity caused by the rotation of an optical disc medium.

In the objective lens driving device 25, the two sensors 16 are attached to the base 19 so as to face the sheet coil 15 in the tangential direction. The two sensors 16 each have a light-emitting portion 17 and a light-receiving portion 18 arranged in the focusing direction. Photointerrupters can be used as the sensors 16. Herein, hinges such as leaf springs can be used as the support members 20. Further, as coils for generating thrusts with respect to the magnets 22, winding coils can be used instead of the sheet coils 15.

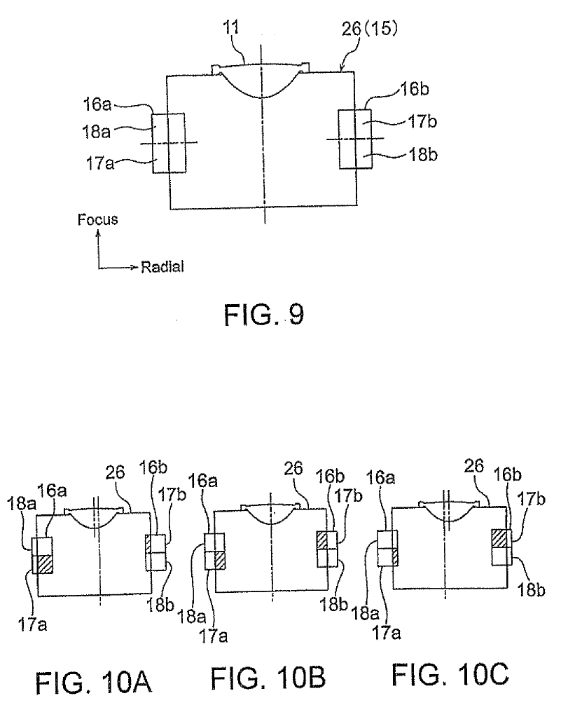

FIG. 9 shows the positional relationship between the actuator movable portion 26 and the two sensors 16. The two sensors 16a and 16b are disposed so that portions thereof in the radial direction overlap with the actuator movable portion 26 (sheet coil 15). Further, the sensors 16a and 16b are arranged symmetrically with respect to the centerlineline, in the radial direction, of the actuator movable portion 26 when it is at the neutral position (displacement in the radial direction=0, radial tilt=0). More specifically, for example, as shown in the same figure, when the actuator movable portion 26 is at its neutral position, the ends, in the radial direction, of the sheet coil 15 are located at positions passing through the centers, in the radial direction, of the sensors 16a and 16b, respectively.

The sensor 16a has the light-receiving portion 18a and the light-emitting portion 17a in the order named from the position closest to the disc, while, the sensor 16b has the light-emitting portion 17b and the light-receiving portion 18b in the order named from the position closest to the disc. That is, in the sensors 16a and 16b, the positions of the light-emitting portions 17 and the light-receiving portions 18 are vertically (in the focusing direction) symmetrical as seen in the tangential direction. Lights emitted from the light-emitting portions 17a and 17b are partially reflected by the sheet coil 15, individually.

The amount of light reflected by the sheet coil 15 is proportional to the amount of light irradiated onto the sheet coil 15, i.e. the area of a portion where the light-emitting portion 17a, 17b overlaps with the sheet coil 15. The light-receiving portion 18a, 18b receives the light reflected by the sheet coil 15. The light receiving amount of the light-receiving portion 18a, 18b is proportional to the light reflecting amount of the sheet coil 15. The sensor 16a, 16b outputs a signal corresponding to the amount of light received by the light-receiving portion 18a, 18b.

FIGS. 10A to 10C show the states of detection of positions, in the radial direction, of the actuator movable portion 26. When the actuator movable portion 26 is displaced toward the inner peripheral side in the radial direction (the left side as facing the drawing sheet), the area of a portion where the sensor 16a overlaps with the actuator movable portion 26 becomes larger than the area of a portion where the sensor 16b overlaps with the actuator movable portion 26 as shown in FIG. 10A. Therefore, an output A of the sensor 16a becomes greater than an output B of the sensor 16b and, thus, if the output B of the sensor 16b is subtracted from the output A of the sensor 16a, a difference A−B takes a positive value.

On the other hand, when the actuator movable portion 26 is displaced toward the outer peripheral side in the radial direction (the right side as facing the drawing sheet), the area of a portion where the sensor 16b overlaps with the actuator movable portion 26 becomes larger than the area of a portion where the sensor 16a overlaps with the actuator movable portion 26 as shown in FIG. 10C. Therefore, if an output B of the sensor 16b is subtracted from an output A of the sensor 16a, a difference A−B takes a negative value. On the other hand, when the displacement, in the radial direction, of the actuator movable portion 26 is 0, the areas of portions where the sensors 16a and 16b overlap with the actuator movable portion 26, respectively, become equal to each other and, thus, the amounts of light received by the light-receiving portions 18a and 18b become equal to each other (A−B=0).

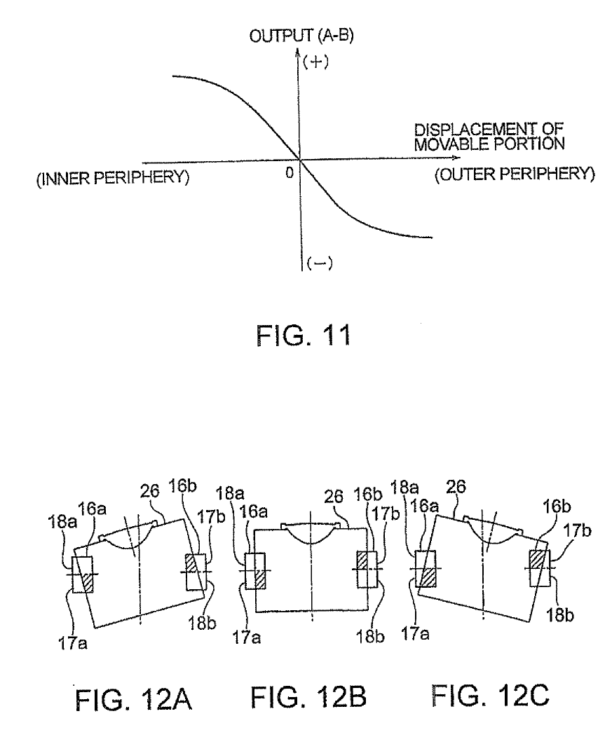

FIG. 11 shows the relationship between the difference A−B of output signals of the two sensors 16a and 16b and the displacement, in the radial direction, of the actuator movable portion 26. The difference A−B derived by subtracting the output of the sensor 16b from the output of the sensor 16a changes depending on the displacement, in the radial direction, of the actuator movable portion 26 as shown in the same figure. Accordingly, by examining the difference A−B between the outputs of the sensors 16a and 16b, it is possible to detect the displacement, in the radial direction, of the actuator movable portion 26.

FIGS. 12A to 12C show the states of detection of tilts, in the radial tilt direction, of the actuator movable portion 26. In the same figures, clockwise rotation of the actuator movable portion 26 is given as rotation in the positive direction. When the actuator movable portion 26 rotates counterclockwise (FIG. 12A), the areas of portions where the light-emitting portions 17a and 17b overlap with the actuator movable portion 26, respectively, become smaller than those when the actuator movable portion 26 is at its neutral position (FIG. 12B). Therefore, the amounts of light received by the light-receiving portions 18a and 18b decrease as compared with those in the neutral state and thus the sum A+B of outputs of the sensors 16a and 16b also decreases as compared with that in the neutral state.

On the other hand, when the actuator movable portion 26 rotates clockwise (FIG. 12C), the areas of portions where the light-emitting portions 17a and 17b overlap with the actuator movable portion 26, respectively, become greater than those when the actuator movable portion 26 is at its neutral position. Therefore, the amounts of light received by the light-receiving portions 18a and 18b increase as compared with those in the neutral state and thus the sum A+B of outputs of the sensors 16a and 16b also increases as compared with that in the neutral state.

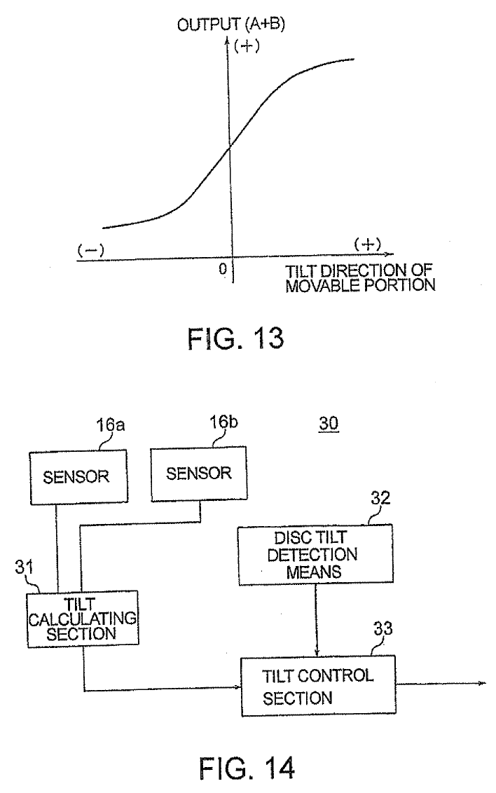

FIG. 13 shows the relationship between the sum A+B of output signals of the two sensors 16a and 16b and the tilt, in the radial tilt direction, of the actuator movable portion 26. The sum A+B of the output of the sensor 16a and the output of the sensor 16b changes depending on the tilt, in the radial tilt direction, of the actuator movable portion 26 as shown in the same figure. Accordingly, by examining the sum A+B of the outputs of the sensors 16a and 16b, it is possible to detect the tilt, in the radial tilt direction, of the actuator movable portion 26.

A description will be given of the operation for correcting the tilt of the objective lens 11 in the optical head device 10. FIG. 14 shows the configuration of an objective lens tilt control section in the optical head device 10. This control section 30 comprises a tilt calculating section 31, a disc tilt detection means 32, and a tilt control section 33. The tilt calculating section 31 calculates a tilt of the actuator movable portion 26 with respect to the base 19 based on a sum signal of outputs of the sensors 16a and 16b. The disc tilt detection means 32 detects a tilt of a disc (disc tilt) with respect to the reference plane using, for example, a tilt sensor. Based on the tilt of the objective lens calculated by the tilt calculating section 31 and the disc tilt detected by the disc tilt detection section 32, the tilt control section 33 determines a tilt command value and supplies a signal to the tilt coil, thereby controlling the tilt of the objective lens to the tilt command value.

The tilt control section 33 determines a tilt command value based on the disc tilt and controls a signal supplied to the tilt coil so that the objective lens 11 becomes parallel to the disc. In the case where the actuator movable portion 26 maintains the designed posture (state), the actual tilt calculated by the tilt calculating section 31 and the tilt command value determined by the tilt control section 33 agree with each other. However, in the case where a tilt occurs due to temperature rise, there arises a difference between the tilt command value and the actual tilt output from the tilt calculating section 31. In this case, the tilt control section 33 corrects the tilt command value determined based on the disc tilt, using the difference between the tilt command value and the actual tilt output from the tilt calculating section 31. Through this control, even when the posture of the actuator movable portion 26 is changed from the designed one, the objective lens 11 and the disc can be maintained parallel to each other.

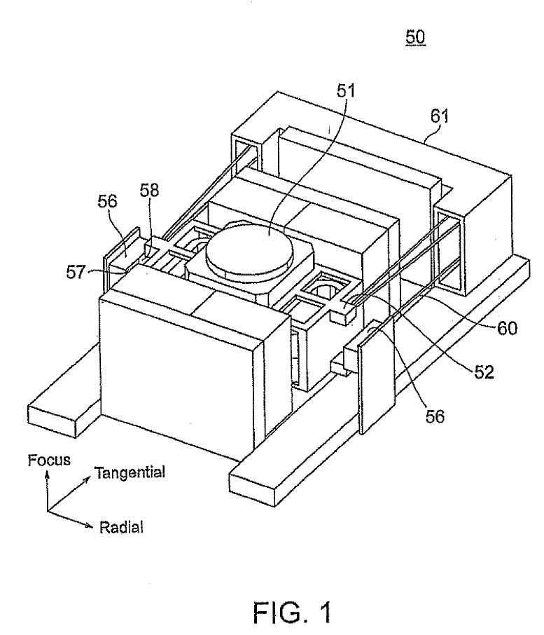

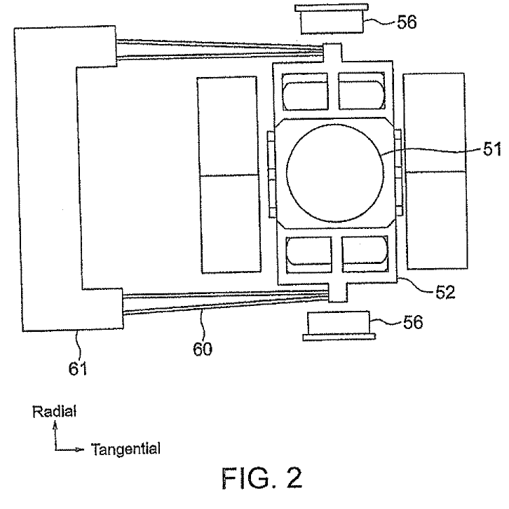

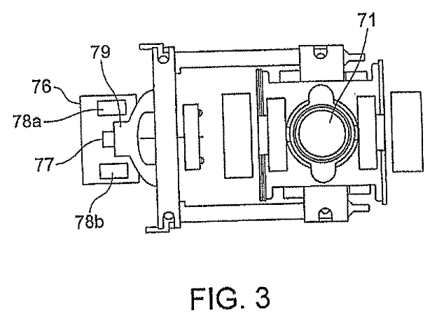

In this embodiment, the two sensors 16a and 16b are arranged in the direction opposed to the lens holder 12 in the tangential direction to thereby detect the displacement and tilt of the objective lens 11. By employing such a structure, the width in the radial direction can be narrowed as compared with the conventional objective lens driving device 50 (FIGS. 1 and 2). Since the objective lens driving device 25 can be reduced in size in the radial direction, there is no occurrence of interference between the carriage 23 and a corn portion of the spindle motor or a turntable in accessing an inner peripheral portion of an optical disc. Accordingly, in this embodiment, it is possible to reduce the restriction of access area and thus is possible to access the innermost peripheral area of the optical disc.

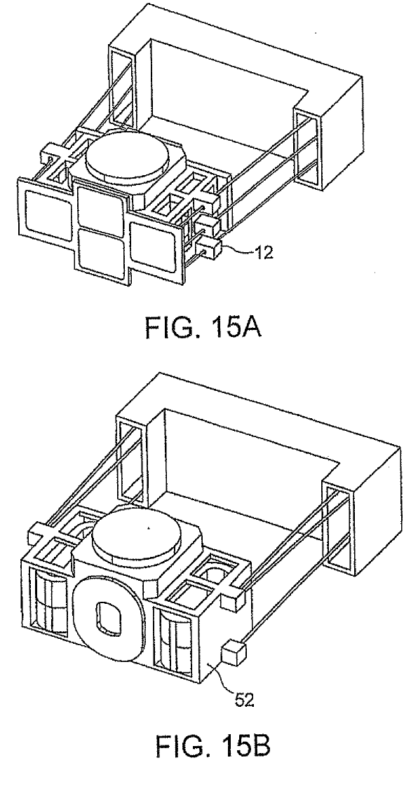

In the conventional objective lens driving device 50, it is necessary that the end surfaces, in the radial direction, of the lens holder 52 be formed flat as shown in FIG. 15B. In contrast, in this embodiment, the end surfaces, in the radial direction, of the lens holder 12 are not required to be flat surfaces and thus can be formed into a hollow, slot, or relief structure as shown in FIG. 15A. In this manner, by hollowing out, slotting, or relieving unnecessary portions at the ends, in the radial direction, of the lens holder 12 so as to optimize the shape and decrease the weight of the lens holder 12, it is possible to achieve improvement in acceleration of the actuator movable portion 26 as compared with the conventional objective lens driving device. Further, by decreasing the weight of the end portions of the lens holder 12, the energy at a bending or twist natural resonance point of the actuator movable portion 26 can be reduced, so that vibration is not easily transmitted to the objective lens 11. Therefore, the frequency characteristics in a high-frequency region can be largely improved.

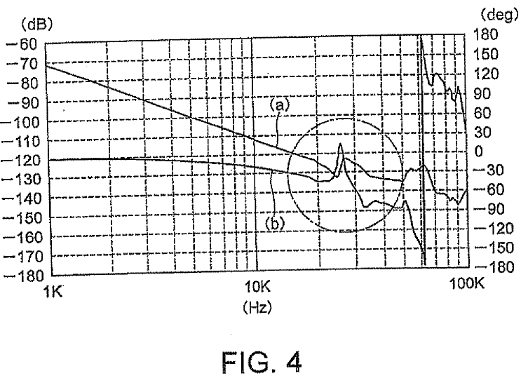

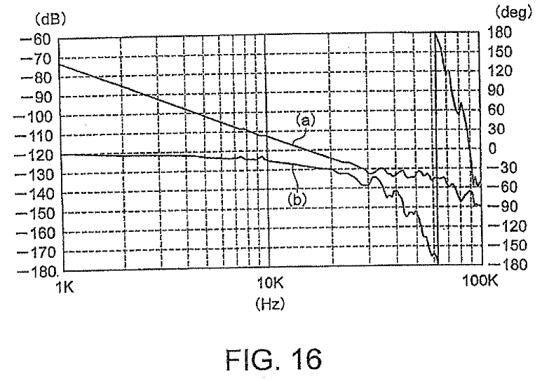

FIG. 16 shows the evaluation results of frequency characteristics in the objective lens driving device 25 of this embodiment. In FIG. 16, graph line (a) represents a gain (dB) determined according to the ratio between an amplitude of a drive signal for the lens holder 12 and its response and graph line (b) represents a drive phase delay. Through a comparison between the frequency characteristics shown in FIG. 16 and the frequency characteristics in the conventional objective lens driving device 50 shown in FIG. 4, it is seen that the influence of resonance appearing in the frequency region of several tens of KHz in FIG. 4 is reduced and it can be confirmed that the frequency characteristics are largely improved. Further, it is observed that although there are some fluctuations, the gain gradually decreases with respect to an increase in frequency. Therefore, using the objective lens driving device 25 of this embodiment, in the optical disc device, it is possible to achieve the servo operation with the stable objective lens position error detection and, further, it is possible to improve the operating band and optimize the tilt correction for the objective lens 11, so that excellent recording/reproducing characteristics can be realized.

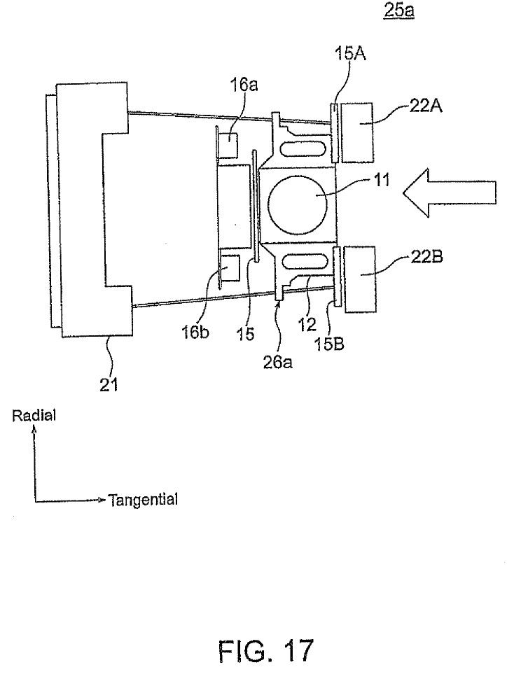

FIG. 17 is a plan view showing part of an objective lens driving device of the second embodiment of this invention. In the objective lens driving device 25a of this embodiment, two sensors 16a and 16b are respectively attached at positions facing a sheet coil 15 on the damper box 21 side (fulcrum side) of an actuator movable portion 26a. A sheet coil 15 on the side, opposite to the fulcrum side, of the actuator movable portion 26a is divided into two (15A and 15B) and a space is provided in the middle therebetween.

In the objective lens driving device 25a, magnets 22A and 22B are mounted so as to face the divided two sheet coils 15A and 15B, respectively. Further, a non-illustrated raising mirror is disposed just under an objective lens 11. In this embodiment, laser light emitted from a laser light source is incident on the objective lens 11 through the raising mirror from the space between the divided two sheet coils 15A and 15B as indicated by a wide arrow in the figure.

The positional relationship between the two sensors 16a and 16b and the actuator movable portion 26a is the same as the positional relationship in the first embodiment shown in FIG. 9. Therefore, like in the first embodiment, the displacement, in the radial direction, of the actuator movable portion 26a can be detected based on a difference between outputs of the sensors 16a and 16b and the tilt, in the radial tilt direction, of the actuator movable portion 26a can be detected based on the sum of outputs of the sensors 16a and 16b. Further, in this embodiment, since the laser light can be incident on the raising mirror through the space between the sheet coils 15A and 15B, an optical head device can be reduced in thickness. Accordingly, it is possible to realize an objective lens driving device that can be mounted in a thin-type optical disc device adapted to be mounted in a note-type PC.

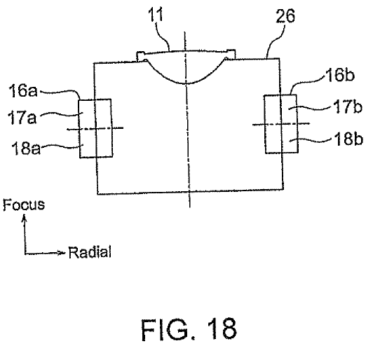

In the foregoing embodiments, the light-emitting portions 17 and the light-receiving portions 18 are vertically symmetrically arranged in the two sensors 16 as shown in FIG. 9. However, instead of it, light-emitting portions 17 and light-receiving portions 18 may be laterally symmetrically arranged in two sensors 16 as shown in FIG. 18. If this structure is employed, the tilt, in the radial tilt direction, of an actuator movable portion 26 cannot be detected, but the displacement in the radial direction can be detected by deriving a difference between outputs of the sensors 16a and 16b like in the case shown in FIGS. 10A to 10C.

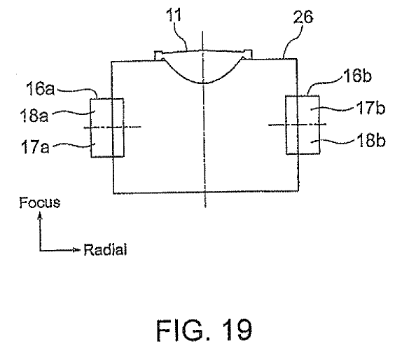

FIG. 9 shows the example in which the ends, in the radial direction, of the sheet coil 15 are located at the positions passing through the centers, in the radial direction, of the sensors 16a and 16b, respectively, but not limited thereto. For example, as shown in FIG. 19, sensors 16a and 16b can be arranged so that the centers, in the radial direction, of the sensors 16a and 16b are located outside the ends, in the radial direction, of a sheet coil 15. Normally, an actuator movable portion 26 is driven with a tilt in a range of about ±1 degree with respect to the neutral position. In the layout shown in FIG. 9, when the displacement occurs near the position where the ends, in the radial direction, of the sheet coil 15 pass through the centers, changes in output of the sensors 16 become sharp with respect to the displacement of the sheet coil 15, so that it may be difficult to detect a slight tilt near the neutral position. In the case where the sensors 16a and 16b are arranged as shown in FIG. 19, changes in output of the sensors 16 near the neutral position become gradual as compared with the case shown in FIG. 9, so that it is possible to detect a slight tilt of the sheet coil 15 near the neutral position.

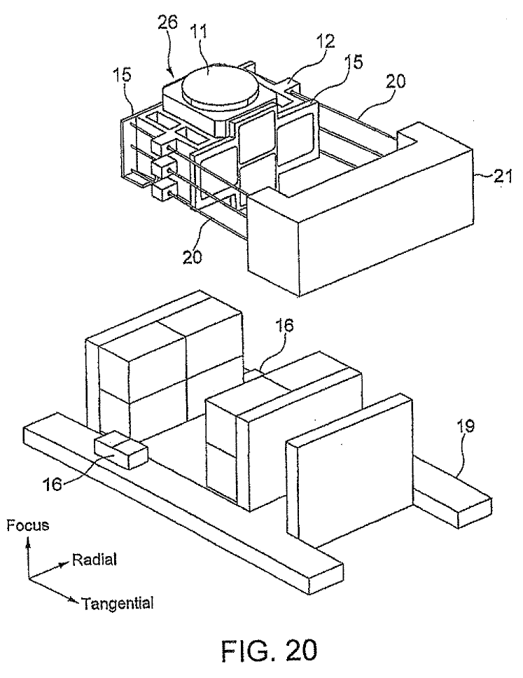

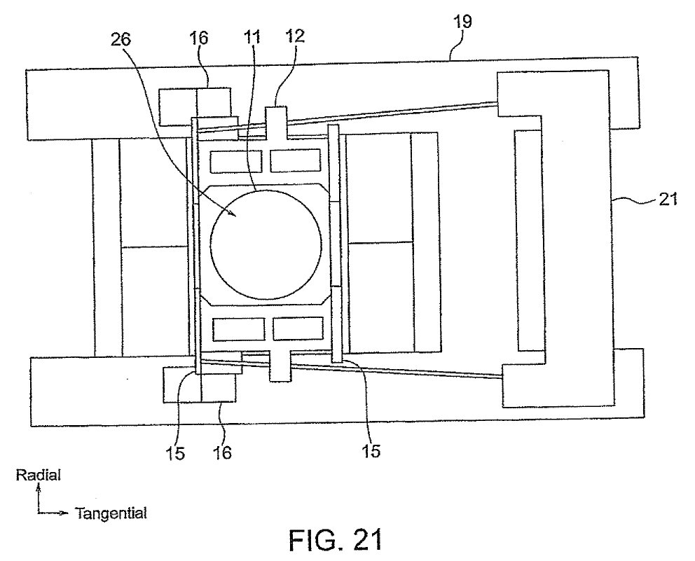

In the foregoing embodiments, the sensors 16 are arranged so as to face the sheet coil 15 in the tangential direction. However, instead of it, sensors 16 can be opposed to an actuator movable portion 26 in the focusing direction as shown in FIGS. 20 and 21. In this case, by forming portions, in the focusing direction, of a lens holder 12 to be flat and opposing those flat surfaces and the sensors to each other, it is possible to detect a displacement and a tilt of the actuator movable portion 26 by the same operations as those in FIGS. 10A to 10C and FIGS. 12A to 12C. Even in the case of employing such a structure, it is not necessary to form a considerable area of either of end surfaces, in the radial direction, of the lens holder 12 to be flat and, therefore, the same effect as that in the first embodiment can be obtained.

In the foregoing embodiments, the two sensors 16 face the sheet coil 15 in the tangential direction. However, instead of it, only a single sensor 16 may face it in the tangential direction. In the case of using the single sensor 16, it may be configured, for example, such that an output of the sensor 16 when the sheet coil 15 is located at the neutral position is stored in advance and a displacement of the sheet coil 15 is calculated based on a difference between the stored output and an output of the sensor 16.

While this invention has been described based on the preferred embodiments, the objective lens driving devices and the optical disc devices of this invention are not limited to the foregoing embodiments and those obtained by applying various modifications or changes to the structures of the foregoing embodiments are also included in the scope of this invention.

1. An objective lens driving device for driving a lens mounting portion, mounted with an objective lens serving to condense light onto an optical disc, in at least a focusing direction and a radial direction with respect to a reference position, said objective lens driving device characterized by comprising
an optical sensor having a light-emitting portion and a light-receiving portion, said optical sensor facing, in the vicinity of an end in the radial direction of said lens mounting portion, an end surface in a tangential direction or the focusing direction of said lens mounting portion,
wherein at least one of a displacement and a tilt of said lens mounting portion is detected based on an output of said optical sensor.

2. The objective lens driving device according to claim 1, wherein said optical sensor faces the end surface in the tangential direction of said lens mounting portion, and said light-emitting portion and said light-receiving portion of said optical sensor are arranged along the focusing direction.

3. The objective lens driving device according to claim 1, wherein said optical sensor faces the end surface in the focusing direction of said lens mounting portion, and said light-emitting portion and said light-receiving portion of said optical sensor are arranged along the tangential direction.

4. The objective lens driving device according to claim 2 or 3, wherein said optical sensor comprises a pair of optical sensors disposed in the vicinity of both ends in the radial direction of said lens mounting portion.

5. The objective lens driving device according to claim 4, wherein said optical sensors are arranged symmetrically with respect to a centerlineline in the radial direction of said objective lens driving device.

6. The objective lens driving device according to claim 4 or 5, wherein a layout order of said light-emitting portion and said light-receiving portion of one of said optical sensors and a layout order of said light-emitting portion and said light-receiving portion of the other of said optical sensors are opposite to each other.

7. An objective lens driving device according to claim 4 or 5, wherein a layout order of said light-emitting portion and said light-receiving portion of one of said optical sensors and a layout order of said light-emitting portion and said light-receiving portion of the other of said optical sensors are the same as each other.

8. The objective lens driving device according to claim 6 or 7, wherein the displacement in the radial direction of said lens mounting portion is calculated based on a difference signal between output signals of said optical sensors.

9. The objective lens driving device according to claim 6, wherein the tilt of said lens mounting portion is calculated based on a sum signal of output signals of said optical sensors.

10. The objective lens driving device according to any one of claims 1 to 9, wherein a center in the radial direction of said optical sensor is located outside an end surface in the radial direction of said lens mounting portion.

11. The objective lens driving device according to any one of claims 1 to 10, wherein the end surface in the tangential direction of said lens mounting portion is formed by a surface of a sheet coil, said sheet coil including drive coils, said drive coils being used for driving said lens mounting portion in the tangential direction, the radial direction, and a tilt direction.

12. The objective lens driving device according to any one of claims 1 to 11, wherein said lens mounting portion is formed with an opening for guiding laser light to be incident on said objective lens.

13. The objective lens driving device according to any one of claims 1 to 12, wherein said optical sensor is a photointerrupter.

14. An objective lens driving device comprising an objective lens, a lens holder mounted with said objective lens, a support member movably supporting said lens holder, a coil member fixed to an end, in a tangential direction, of said lens holder, and a magnet facing said coil member, thereby moving said lens holder in at least a radial direction and the tangential direction, said objective lens driving device characterized by comprising
a pair of optical sensors each of which has a light-emitting portion and a light-receiving portion arranged along a focusing direction, and which face, in the vicinity of both ends in the radial direction of said lens holder, an end surface in the tangential direction or the focusing direction of said lens holder,
wherein at least one of a displacement and a tilt of said lens holder is detected based on outputs of said optical sensors.

15. An optical disc device for irradiating laser light onto an optical disc to perform recording/reproduction of information, wherein said optical disc device comprises said objective lens driving device according to any one of claims 1 to 14.
